(19) United States
(12) Patent Application Publication
(10) Pub. No.: US 2007/0114861 A1
(43) Pub. Date: May 24, 2007

(54) Rollen and rollenmotoren

(75) Inventors: Erich Bott, Hollstadt (DE); Markus Platen, Bad Neustadt (DE); Sebastian Rader, Bastheim (DE); Rolf Vollmer, Gersfeld (DE); Markus Ostreich, Schlitz (DE)

Correspondence Address: HENRY M FEIEREISEN, LLC, 350 FIFTH AVENUE, SUITE 4714, NEW YORK, NY, 10118, US

(73) Assignee: SIEMENS AKTIENGESELLSCHAFT, MUNCHEN (DE)

(21) Appl. No.: 10/558,906

(22) PCT Filed: Apr. 26, 2004
(86) PCT No.: PCT/EP04/04399

§ 371 Date: Sep. 25, 2006

(30) Foreign Application Priority Data
May 30, 2003 (DE) 103 24 664.9

(51) Int. Cl. H02K 9/00; H02K 1/32; H02K 11/00

(52) U.S. Cl. 310/71; 310/156.19; 310/61; 310/58; 29/596

(57) ABSTRACT

The aim of the invention is to improve the production, design, and effectiveness of rollers or roller motors. Said aim is achieved by using a plastic support unit for the individual magnets in order to produce a multipole motor that has a small diameter and can be integrated into a roller. Said plastic support unit can be unscrewed after being incorporated into a return tube. Additionally, a roller comprising an integrated roller motor (24) is cooled by means of an external or internal cooling device (25, 26) so as to increase constant torque. Furthermore, in order to reduce the design of rollers which have to be braked as well, a braking device is provided which can be integrated into the roller. And finally, in order to simplify contacting of the stator during the production thereof, a divisible arbor is provided which comprises corresponding contact supports on both parts of the arbor.

The present invention relates to roller motors and rollers in which such roller motors are integrated. The present invention also relates to method for producing roller motors and methods for dissipating heat from rollers with an integrated roller motor.

External rotor servo motors with a small diameter bore frequently require expensive polished ring magnets for the rotor. It is also difficult to coaxially align ring magnets with a flux return tube with the required accuracy and to attach the magnets in the tube.

The motors used in the past often had only a small number of poles. Rotor rings with a number of individual segments equal to the number of poles were therefore easy to assemble, without resorting to a complex installation process. Moreover, the smaller energy densities of the employed permanent magnets were previously usually adequate. Conversely, modern motors with a large number of poles require high energy densities and small pole gaps. This is difficult and costly to implement with permanent magnets made in one piece. Although individual segments in lieu of a one-piece ring magnet or of only a few individual segments, which would also have to be polished, produce a high energy density and small pole gaps, their assembly is quite complex.

Another problem in the manufacture of roller motors, which are typically implemented as external rotor motors, is that interconnecting and tying together the winding heads of the stators requires considerable manual labor. The electric supply wires must also be routed through the shaft of the respective stator. However, threading the wires also represents a relatively complex installation process. To avoid threading the wires, a motor shaft with a longitudinal slot could be used, in which the wires would be inserted from the side. However, a slot in the shaft has a detrimental effect on the bearing.

For the above reasons, the wire ends of the windings of an external rotor motor are typically manually interconnected or connected to the terminal wires or connecting wires, typically through twisting or welding. The connections must then be insulated and tied to the winding head. Because of the aforementioned disadvantages of a slotted shaft, the terminal wires must still be routed from the motor to the outside through the hollow shaft. In addition, any required control lines or signal lines are also threaded through the hollow shaft.

Disadvantageously, rollers with integrated roller motors also generate heat. In general, a modular and compact design provides cost advantages in the manufacture of roller and belt transport systems due to the shorter on-site assembly time. The drives of the transport system can be constructed in modular form by arranging the motors inside the rollers in form of so-called roller motors. However, this causes heating of the rollers, as described before.

The roller surfaces are typically not protected from being touched, so that according to universal regulations a temperature of approximately 75° must not be exceeded. However, the heat transfer coefficient from the roller surface to the environment is relatively small. The resulting smaller heat transfer to the surroundings limits the continuous torque of roller motors. A solution for the heat transfer problem of roller motors requires additional measures, such as a very small installation space and modest maintenance requirements. For these reasons, roller motors which are currently mostly implemented as internal rotor motors with gears are rarely a viable solution.

In certain applications, or rollers must also be decelerated or slowed down. The same applies to the corresponding drives. Braking systems are typically attached to the cylinders or rollers. Another possibility for braking is to decelerate the cylinders or rollers by using the already existing drive elements. However, the aforementioned braking systems disadvantageously tend to occupy a relatively large volume.

It is therefore an object of the present invention to provide roller motors and rollers which satisfy these requirements by having favorable installation costs and minimal space requirements.

According to the invention, the object is solved by a roller motor with an external rotor having a plurality of individual magnets which are arranged on the inner circumference of a flux return tube, and a support unit which is arranged at least partially radially inside the individual magnets and which has axially extending, outwardly oriented spacers for spacing the individual magnets in the circumferential direction.

Likewise, a method is provided for producing a roller motor or an external rotor motor by providing a tubular support unit with axially extending, outwardly oriented spacers for spacing the individual magnets, affixing several individual magnets or magnet blanks on the outside circumference of the support unit, wherein each of the individual magnets or magnet blanks is affixed between two corresponding spacers, and inserting and fixing the support unit with the individual magnets or magnet blanks in a flux return tube.

The support unit according to the invention can be employed with roller motors where a pole with several individual magnets is employed instead of a cylindrically ground pole segment, which is very expensive to manufacture. The support unit of the invention can also be used with roller motors and/or external rotor motors having a large number of poles, wherein one individual magnet is used for each pole. In both cases, this support unit advantageously forms essentially a tube or a sleeve, to which the individual magnets can be applied from the outside.

The support unit can be made of plastic which can be manufactured inexpensively. The support unit can also include adhesive beds in which an adhesive affixes the individual magnets to the support unit. The support unit with the individual magnets can then be easily inserted in a flux return tube.

The support unit can also be pressed against the flux return tube by a spreading arbor and secured with an adhesive. The tube of the support unit can have a reduced wall thickness in one or several sections to attain an advantageous expansion characteristic.

After the flux return tube is installed, it can be turned out or hollowed out, leaving essentially only the spaces between the individual magnets or the magnet blanks. The spacing between stator and rotor can thereby be reduced to a minimum. The spacers, which align the individual magnets in the axial direction before and after they are attached in the flux return tube remain in place.

If not all the prefabricated individual magnets are used in the manufacture of the external rotor, then the magnet blanks can be magnetized after they have been mounted or affixed in the flux return tube.

The invention also provides a roller motor with a shaft on which a stator is arranged, and a contacting device for contacting the stator with power supply lines. The shaft is divided into a first shaft section and a second shaft section, and the contacting device includes two contact supports. A first contact support is arranged on the first shaft section and a second contact support is arranged on the second shaft section. The first and the second contact supports are removably plugged into each other for forming an electrical connection.

In roller motors of a type where the contacting device has two contact supports by which the power supply lines contact the stator, the first contact support can include clamping devices for interconnecting at least the winding head of the stator. With this arrangement, the stator can advantageously be wound and simultaneously electrically interconnected using an automatic winding machine. At least one of the clamping devices can have an insulation displacement contact.

A sensor, in particular an infrared sensor for monitoring the winding temperature, can be arranged on the first contact support associated with the stator laminate. The sensor can also be electrically contacted via the two contact supports.

The clamping devices can not only be used for interconnecting the windings of the stator, but also for affixing free ends or slack sections of the winding wires. This obviates, for example, the need to tie the winding sections down.

The second shaft section can be hollow. The wires for contacting the contact support can then be routed to the interior of the second shaft section through one or more radial bores or recesses, where they can extend in the interior of the second shaft to its end.

Advantageously, a plug which is electrically connected with the second contact support is arranged in the end of the second shaft section that faces away from the first shaft section. This allows a modular construction of the roller motor.

The aforementioned object is also solved by a roller with an integrated roller motor and a cooling device which is also integrated in the roller or is located outside the roller.

A corresponding method for removing heat from at least one section of a roller in which a roller motor is integrated is also provided. According to the method, the dissipated heat of the roller motor is transported to a cooling device, which is also integrated in the roller or is located outside the roller.

Preferably, the cooling device includes a heat sink and a first heat pipe. This heat pipe, which is known from refrigeration engineering, can effectively transport the heat from the roller motor to the heat sink.

Advantageously, the roller motor is an external rotor motor, whereby the outer tube of the roller functions as flux return tube of the external rotor motor. In this way, a decentralized, maintenance-free drive for a roller or belt transport system can be implemented.

The outer tube of the roller can be divided into sections perpendicular to its axial direction, and the roller motor can be arranged in one of the sections. This may have advantages when installing the roller system.

A thermal insulation layer can be applied to the roller surface. This prevents overheating of the transported goods, but can also prevent burns from touching the rollers.

Optionally, heat can be transported from the heat sink to a bearing shield of the roller by a second heat pipe which protrudes into the cooling device. The cooling element thereby also removes heat effectively from the interior of the roller.

According to an advantageous embodiment, a bearing shield can be implemented as a fan wheel or as a separate fan wheel arranged inside the roller. Cooling can be achieved by circulating air, vented air, hollow shaft ventilation and/or air gap ventilation. In addition, the cooling device can include a self-ventilated fan, a separate fan, a heat wiper, a heat-conducting roller or a heat pump.

Preferably, the roller motor is implemented as a harmonic motor. This has the advantage that the actual field of the stator can be better utilized.

It is frequently necessary for controlling the roller motor to determine the rotor position or the rotor speed. These can be determined indirectly by tapping an EMF (electromotive force) in the roller motor.

In a particular embodiment of the roller motor, the slots of the roller motor can be closed by radially inserting a round material.

According to the invention, a roller is also provided with a shaft, on which the roller is supported for rotation, wherein a braking device for braking the roller is arranged inside the roller.

The braking device can be indirectly coupled to the outer tube of the roller via a roller motor which is integrated in the roller. The braking device can also be arranged in a roller motor that is integrated in the roller. This combination of braking system and drive unit facilitates and simplifies the installation.

Preferably, the braking unit is implemented electromagnetically. Such brakes are very reliable in roller systems and can be easily controlled.

Advantageously, the shaft on which the braking device is arranged is hollow. The power supply lines for the braking device can then be routed through the shaft.

In general, the present invention can be employed with any type of external rotor motors, in particular also with harmonic motors, and is not limited to roller motors.

The present invention will now be described with reference to the appended drawings, in which:

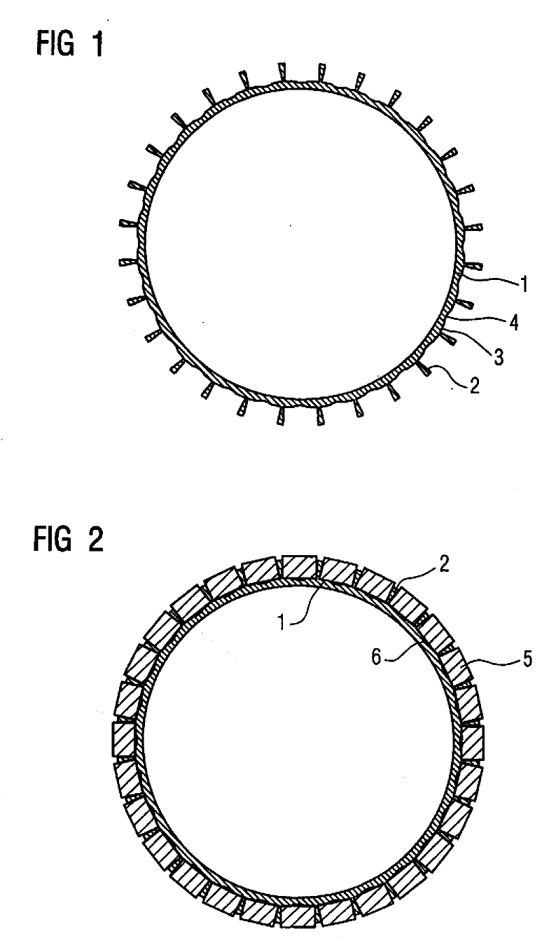

FIG. 1 shows a cross-section through a support unit according to the invention;

FIG. 2 shows the support unit of FIG. 1 with inserted individual magnets;

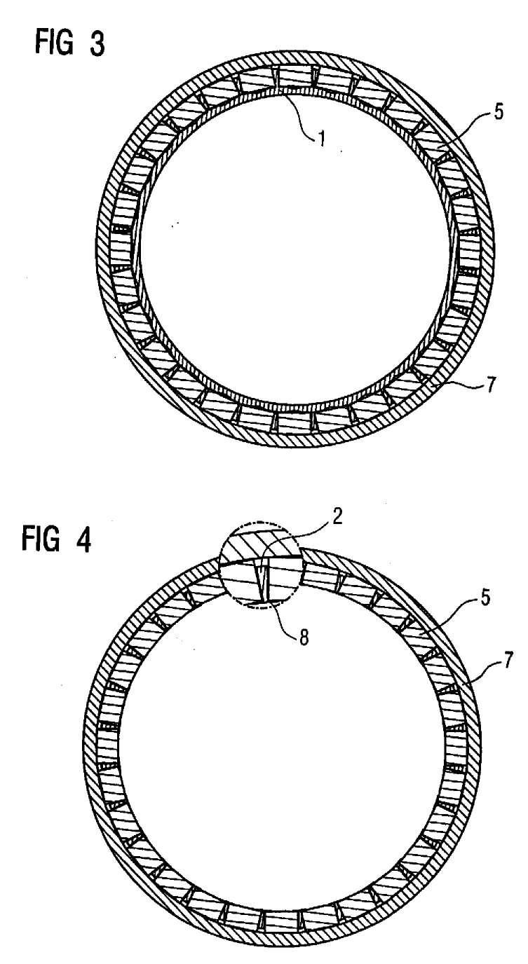

FIG. 3 shows an arrangement according to FIG. 2 with an applied flux return tube;

FIG. 4 shows an arrangement according to FIG. 3 with a turned-out support unit;

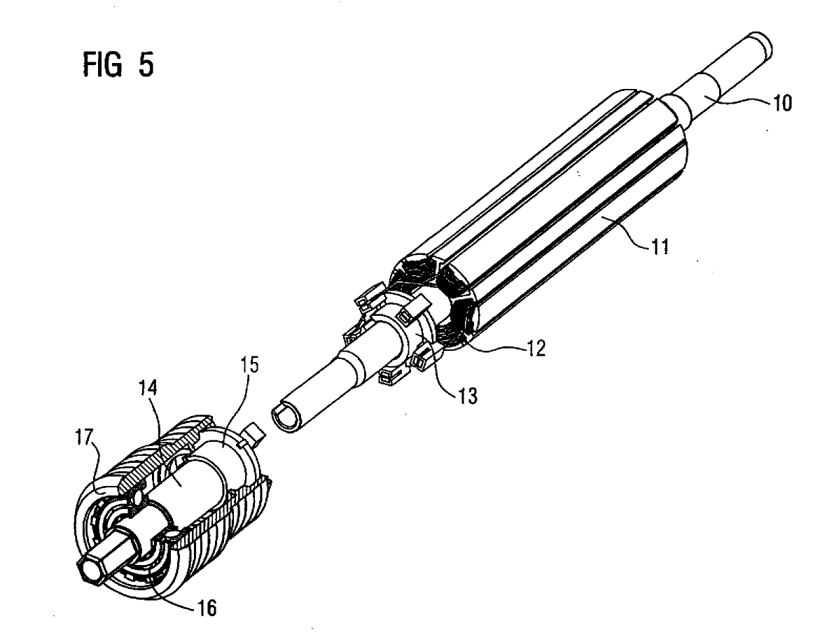

FIG. 5 shows a perspective view of a roller motor with a separable shaft;

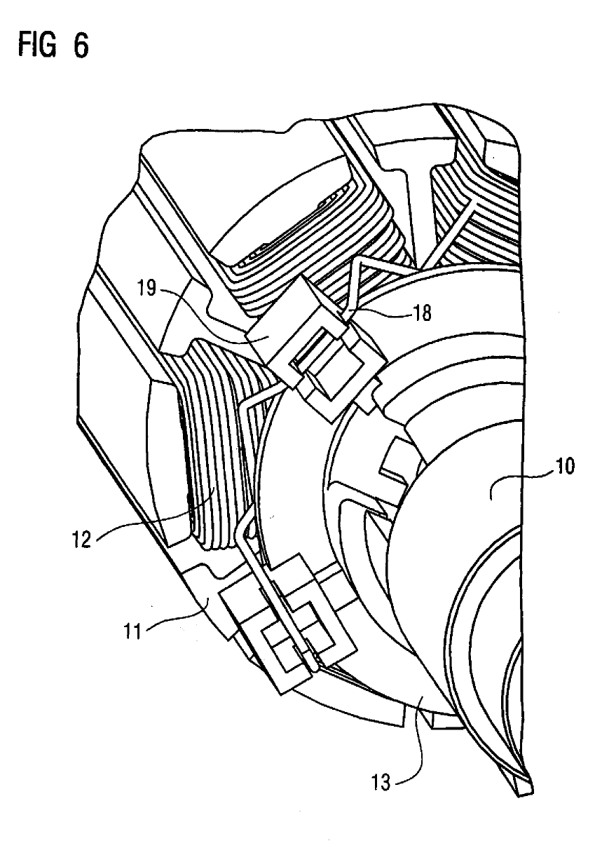

FIG. 6 shows a detailed view of a contact pad on the stator winding head;

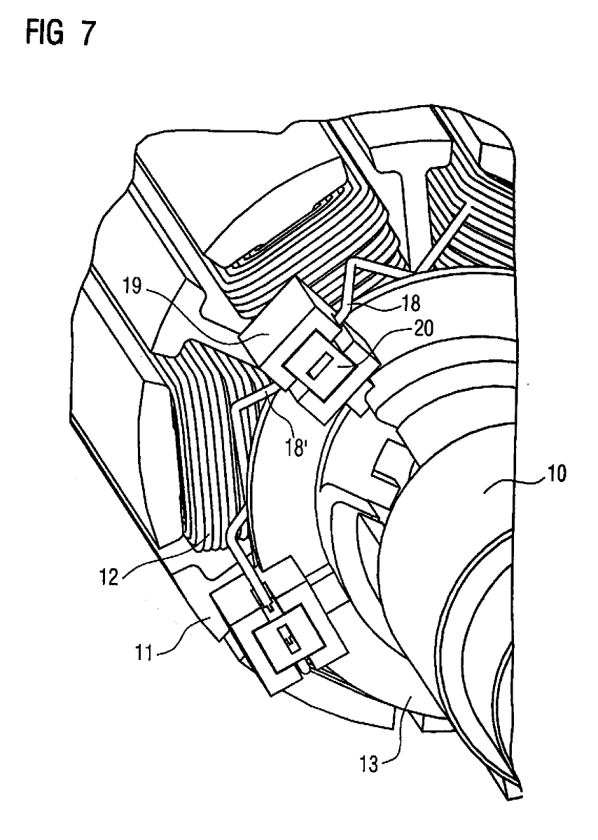

FIG. 7 shows a detailed view of FIG. 6 with inserted insulation displacement contacts;

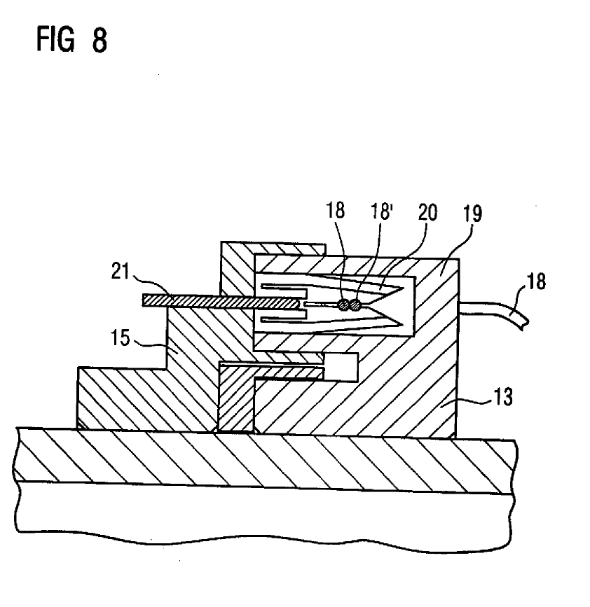

FIG. 8 shows a cross-sectional view through two connected contact pads with an insulation displacement contact;

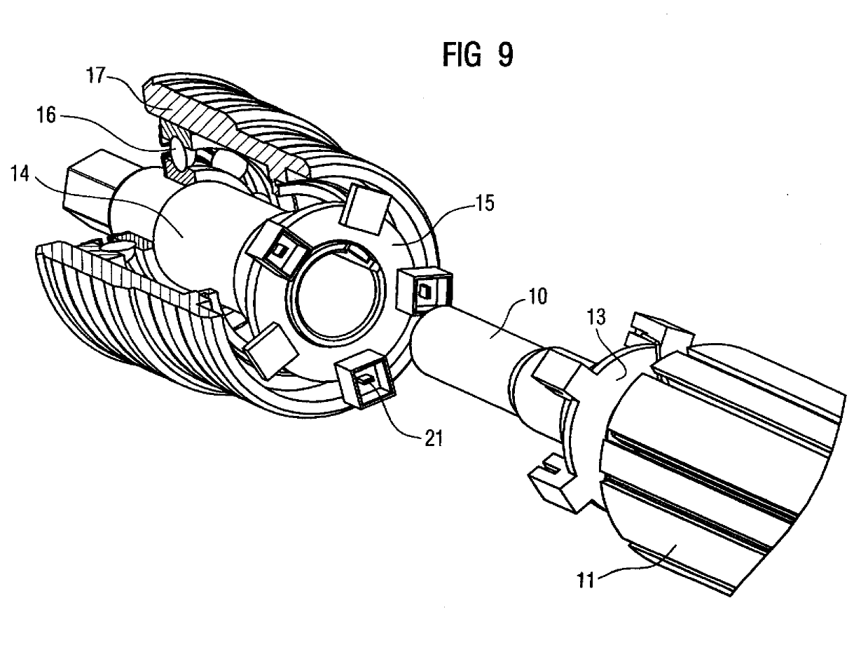

FIG. 9 is a perspective detailed view of the second shaft section used for making contact;

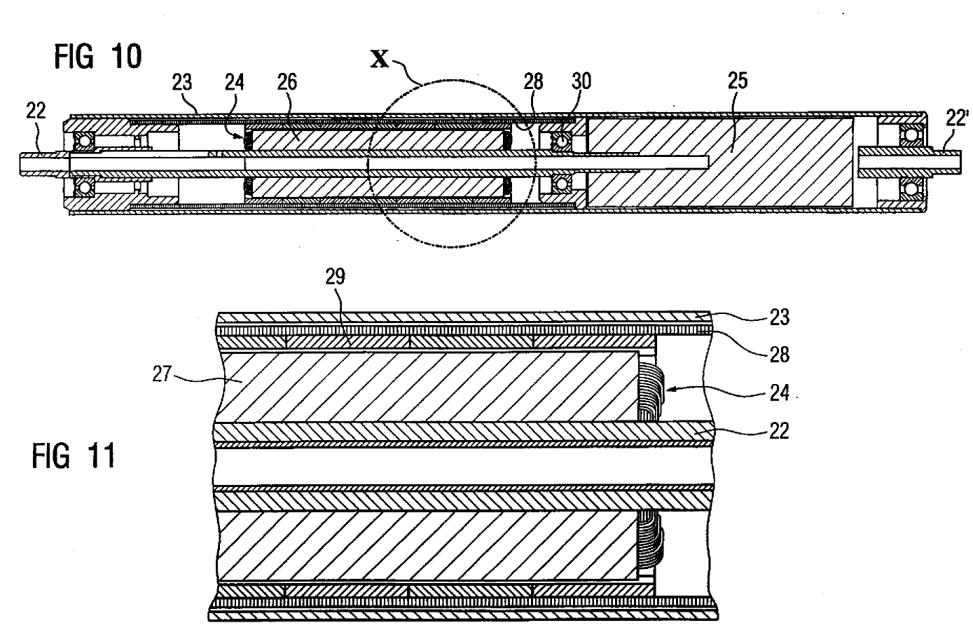

FIGS. 10 to 29 show cross-sectional views and top views of rollers with different cooling devices;

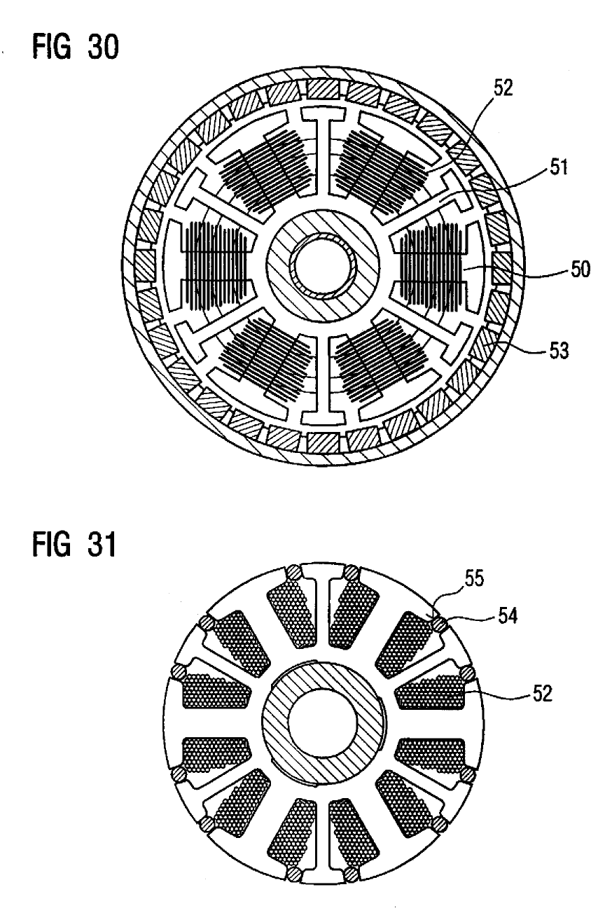

FIG. 30 shows a cross-section through a harmonic external rotor motor;

FIG. 31 shows a cross-section through a stator with a special slot closure;

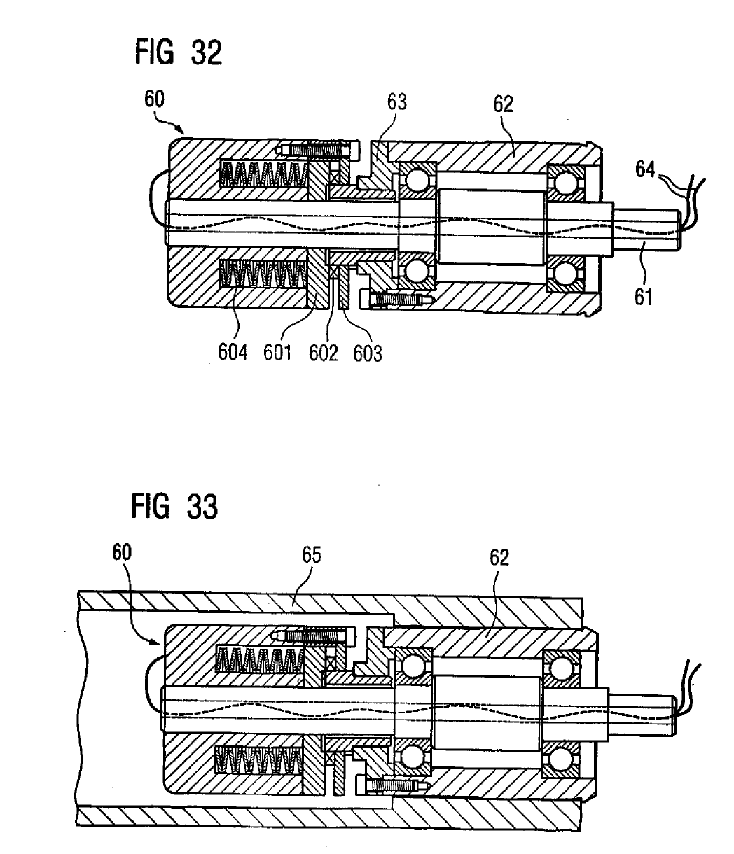

FIG. 32 shows a cross-section through a roller motor with a braking device coupled according to the invention; and

FIG. 33 shows a cross-section through the unit depicted in FIG. 32 and installed in a tube.

The following embodiments described hereinafter in greater detail represent preferred embodiments of the present invention.

As mentioned above, the costs of manufacturing a ground ring magnet are relatively high. The ring magnets are therefore frequently replaced by several individual magnets. However, the large number of individual magnets or unmagnetized magnet blanks required for an external rotor motor is difficult to install in a flux return tube. In particular, the axial alignment of the individual magnets is difficult to maintain during assembly. The magnets are therefore often magnetized after installation in the flux return tube. However, if the flux return tube is too thick, the diameter of the arrangement too small, or the number of poles of the external rotor too large, then a later magnetization is typically not possible.

For these reasons, an external rotor installed according to the invention in the support unit depicted in FIG. 1. The support unit is preferably made of plastic and consists essentially of a tubular support sleeve 1. The support sleeve 1 includes a plurality of radially outwardly oriented spacers 2 which form ribs in the axial direction. An individual magnet is arranged on support faces 3 disposed between two corresponding spacers 2. Adhesive beds 4 which can be filled with adhesive are provided to fix the position of the individual magnets.

FIG. 2 shows in cross-section a support unit, in which individual magnets 5 are inserted from the outside. These are fixed in position with adhesive 6 and are mutually aligned in the axial direction with spacers 2. The spacers 2 disposed in the pole gaps also create capillary gaps which promote the distribution of the adhesive 6 or of a sealing compound. Accordingly, only an adhesive reservoir must be provided on the support sleeve 1 for assembly.

The cross-sectional view of FIG. 3 shows an embodiment where the assembly of FIG. 2 is built into a flux return tube 7. The assembly including the support sleeve 1 and the individual magnets 5 is sealed in the flux return tube 7. The dimensions of the spacers 2 are selected to produce in the flux return tube 7 capillary forces suitable for casting or gluing.

The prefabricated ring depicted in FIG. 2 can be pressed against the flux return tube 7 using a spreading arbor which is inserted in the support sleeve 1. The air gap resulting from the tolerances relative to the flux return tube 7 can then be minimized. Advantageously, the support sleeve 1 can be produced to have sufficient elasticity. This can be achieved by selecting is suitable plastic or, for example, by partially reducing the wall thickness of the support sleeve.

In a final fabrication step for the external rotor, which is shown in FIG. 4 in a cross-sectional view, the space in the support sleeve 1 located between the rotor assembly depicted in FIG. 3 and the permanent magnets 5 is hollowed out. This produces a smaller air gap between rotor and stator with the required precision. Because of the individual magnets 5 have a rectangular cross-section, a residual support section 8 remains on the interior wall of the rotor between each pair of individual magnets 5. However, the individual magnets 5 on the rotor interior wall are turned out to be exposed.

By implementing the support sleeve as a so-called “partially disposable auxiliary part”, the insertion of magnets into a tube which is typically a rather complex process is simplified and now involves applying the individual magnets in a radial direction from the outside, a process which can be easily automated.

Contacting, interconnecting and tying together a stator of an external rotor motor or roller motor is relatively complex. The production process can be simplified and/or automated by employing a stator with a divided shaft according to the present invention, as illustrated in FIG. 5. A stator sheet metal laminate 11 with windings 12 is arranged on a first shaft section 10. A first contact support 13 on the stator side contacts the windings 12.

The first shaft section 10 can be inserted in a second shaft section 14. A second contact support 15 adapted to contact the first contact support 13 is arranged on the end of the second shaft section 14 facing the stator. A bearing bushing 17 is supported on the second shaft section 14 by a ball bearing 16.

FIG. 6 shows in detail the first contact support 13 including the terminals of the stator windings 12. A winding wire 18 is routed through form contours 19. The wire can be automatically wound directly by a winding machine, thereby reducing the manual labor component for connecting and tying down the wires. The winding start and the winding end can also be affixed at defined locations by the form contours 19 of the contact support 13 which is arranged before the winding 12 in the axial direction.

The wires can be interconnected by a machine in those places where the interconnected winding wires 18 are temporarily affixed by a form contour 19. They can be connected by welding or, as shown in FIG. 7, by an insulation displacement contact which is pressed into a pocket. Wires can thereby be connected to other wires without cutting them. In addition, slack elements can be connected without tying them down.

FIG. 8 shows a cross-section through an insulation displacement contact 20 which is integrated in the form contour 19. The first contact support 13 is hereby inserted in the second contact support 15. Electric contact is established by connecting the insulation displacement contact 20 with an outside wire 21 which is integrated in the second contact support 15. Two winding wires 18 and 18′ are inserted in the insulation displacement contact 20 for connecting the wires.

As mentioned above, the insulation displacement contact 20 can be used to fix a winding end. However, a loose form contour 19 of suitable shape without an insulation displacement contact is adequate for securing a slack section of the winding (see FIG. 6).

The contact support 13 is also suitable as a support for an infrared sensor (not shown) which can be used to monitor the winding temperature. The infrared sensor can also be contacted using insulation displacement contact technology. Electric contact can also be made via the second contact support 15.

The second shaft section is hollow so that wires can be routed through the shaft section and the first shaft section 10 can be inserted. The connecting wires 21 of the second contact support 15 are routed to the inside of the second shaft section 14 through radial bores or recesses, which is not shown in FIG. 9.

A connecting plug for the motor is located inside the end of the second shaft section 14 facing the stator (not shown). The contact elements of the other side of the connecting lines 21 are secured in the connecting plug. The plug with a form contour arranged on the contact support and the wires is pushed through the bearing bushing to its end position, where the plug is supported by the bearing bush.

The second shaft section 14 is formed as a bearing bushing in the region of the bearing support of the ball bearing 16, so as to provide a high-quality bearing seat. When the bearing bushing or the second shaft section 14 is pressed onto the first shaft section 10, the contact elements disposed in the two contact supports 13 and 15 are also connected.

Dividing the shaft according to the invention does not only facilitates the installation of the roller, but advantageously also simplifies the production of the self-driven roller, because the second shaft section 14 does not need to be slotted and the connecting lines for the winding do not need be threaded through a longer tube. As mentioned above, by suitable shaping the form contours 19 of the first contact support 13, the stator winding can be automatically wound and interconnected, thus obviating the need for tying down the winding.

By integrating the roller motor in the roller, a maintenance-free drive for a roller or belt transport system can be implemented. According to the invention, cooling devices are provided in the rollers to address problems associated with heat removal. For example, a permanent-excited three-phase synchronous motor with a large number of poles can be employed to keep the overall electric heat dissipation low.

FIG. 10 shows a cross-sectional view of an embodiment of a roller of this type. The outer tube 23 of a roller is supported on a divided shaft 22, 22′. Inside the roller, an external rotor motor 24 and a heat sink 25 are supported on the shaft section 22. The dissipated heat is transported from the external rotor motor 24 to the heat sink 25 through a heat pipe 26 in a manner known from cooling systems.

FIG. 11 shows an enlarged detail X of FIG. 10. The stator 27 mounted on the shaft 22 can be clearly seen. The external rotor is made, in a manner known the art, of a flux return tube 28 and several permanent magnets 29 arranged on the interior surface of the flux return tube 28. To accurately maintain the air gap between the stator 27 and the external rotor 28, 29, the midsection of the flux returned tube 28 is supported by a bearing 30, as seen in FIG. 10.

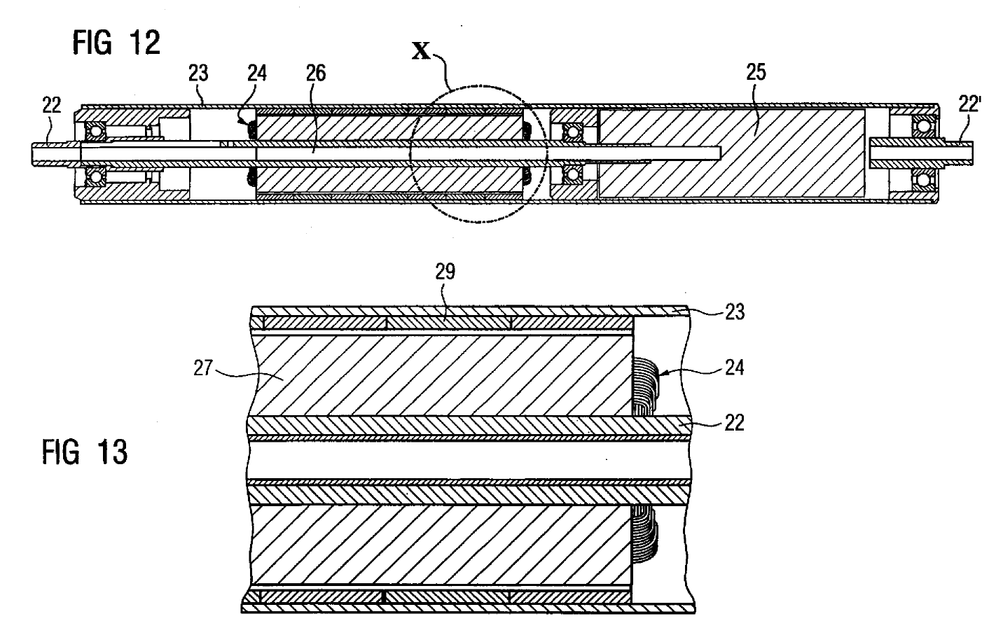

With the heat pipe 26, a portion of the dissipated heat can be removed in the axial direction from the motor 24 via the cooling element 25 to the outer tube 23 of the roller. Heat removal from the motor can be improved and the torque can be increased by using a larger section of the roller surface and other constructive measures, which will be described in connection with the following FIGS. 12 to 31.

FIGS. 12 and 13 show a second embodiment of a roller with heat removal. The construction of the roller is essentially identical to that of FIGS. 10 and 11. The only difference is that in the second embodiment the outer tube 23 assumes the function of the flux return tube. The outer tube must have suitable magnetic properties. An enlarged view of detail X of FIG. 12 is again shown in FIG. 13.

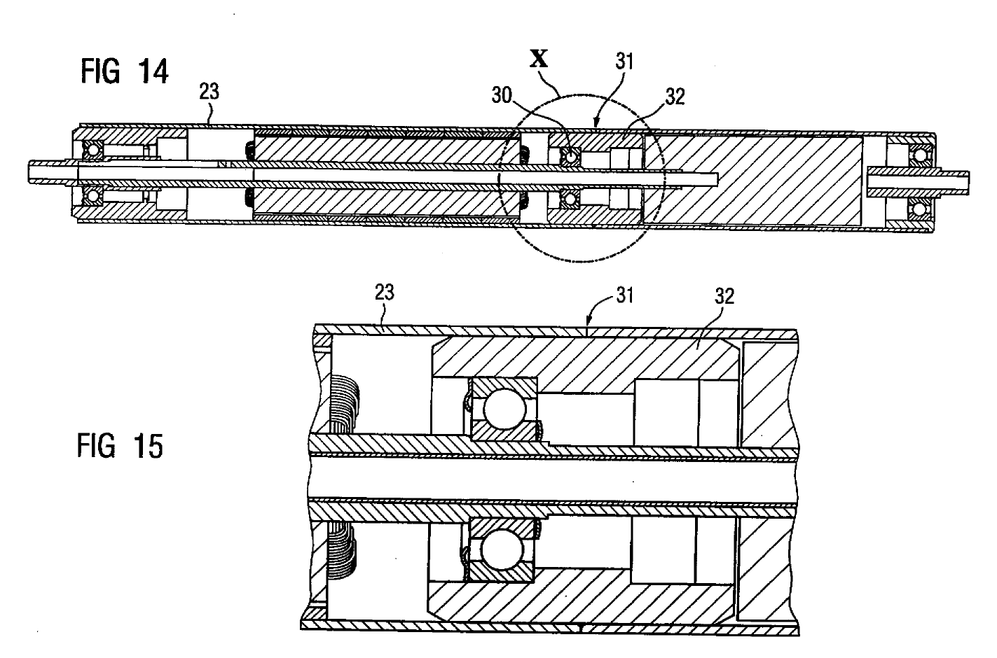

A third embodiment of a roller with heat removal is shown in FIGS. 14 and 15. The enlarged detail X of FIG. 14 is again shown in FIG. 15. The construction of the roller is essentially identical to that of FIG. 12 and 13, respectively. However, one difference is that the outer tube 23 of the roller is divided by a partition 31 approximately in the center of the roller, producing two halves. In the center of the roller, the bearing bushing 32 on the bearing 30 is somewhat enlarged in the axial direction. Dividing the outer tube 23 by partition 31 can have advantages for the installation.

To prevent overheating of the transported articles or burns from physical contact, a heat insulation layer (not shown) can be partially applied on the roller surface. Such protection against physical contact can be provided, for example, by employing netting. Heat can be removed through the netting as before, for example, by convection.

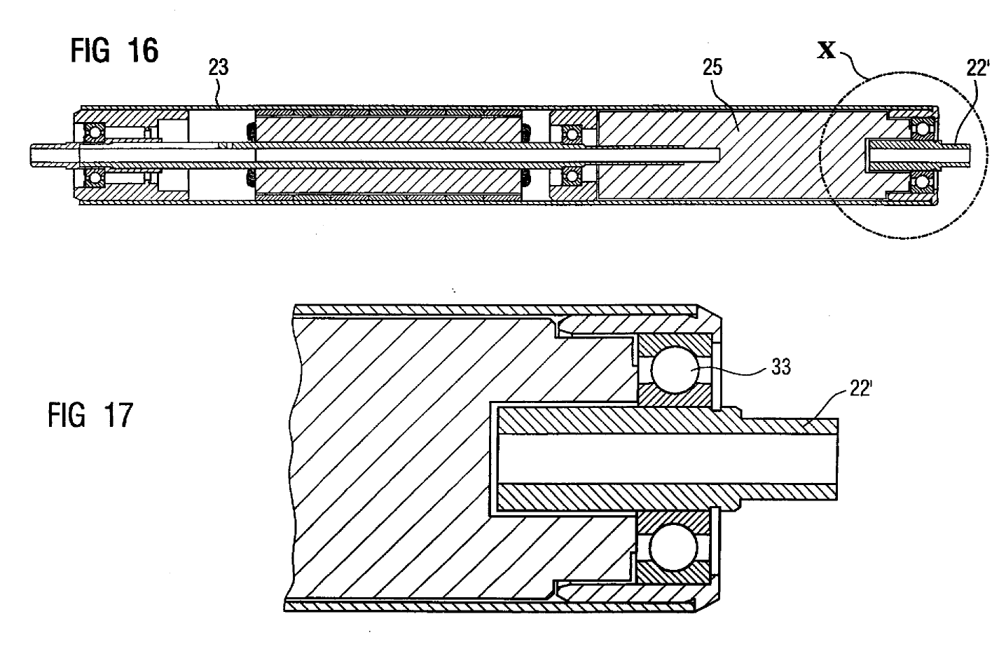

A fourth embodiment for removing heat from a roller with an integrated roller motor is shown in FIGS. 16 and 17. FIG. 17 shows, as before, an enlarged detail X of FIG. 16. Heat is removed passively not only via the roller surface, but also in the axial direction. Stated differently, the heat sink 25 carries the heat away also through the shaft section 22′, which functions here also as a bearing shield. The heat sink 25 which is non-rotatably connected with the shaft section 22′ is formed around the bearing shield 22. The heat sink 25 also extends to the bearing 33.

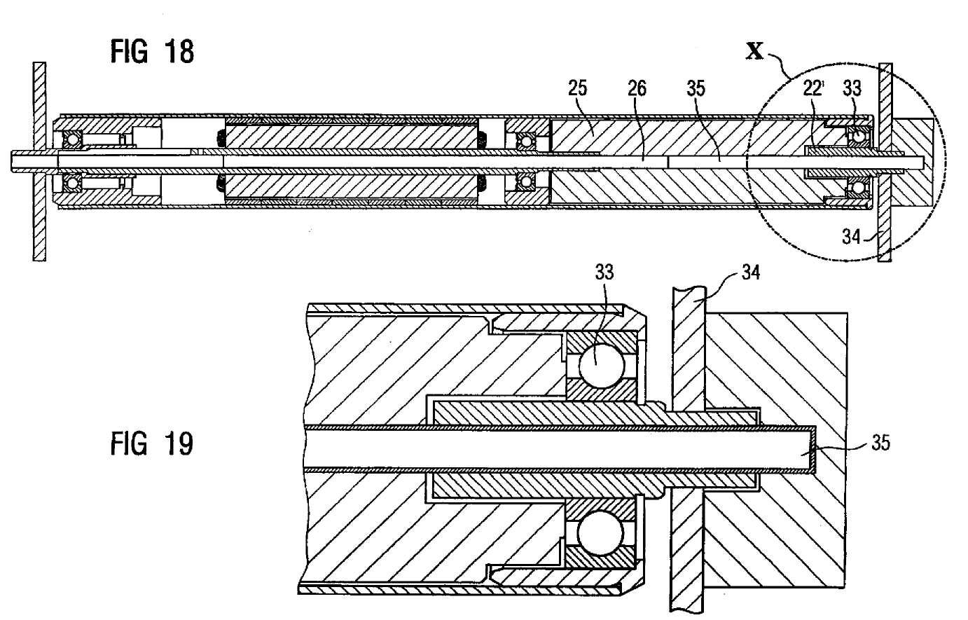

A fifth embodiment for removing heat from a roller is shown in FIGS. 18 and 19. FIG. 19 shows, as before, an enlarged detail X of FIG. 18. The fundamental configuration of the roller corresponds to that of FIG. 16. In addition, the bearing shield and the shaft section 22′, respectively, are thermally connected to an aluminum face 34, where the roller is attached. A second heat type 35 which projects from the roller through the bearing 33 can be used to improve heat transfer to the aluminum face 34.

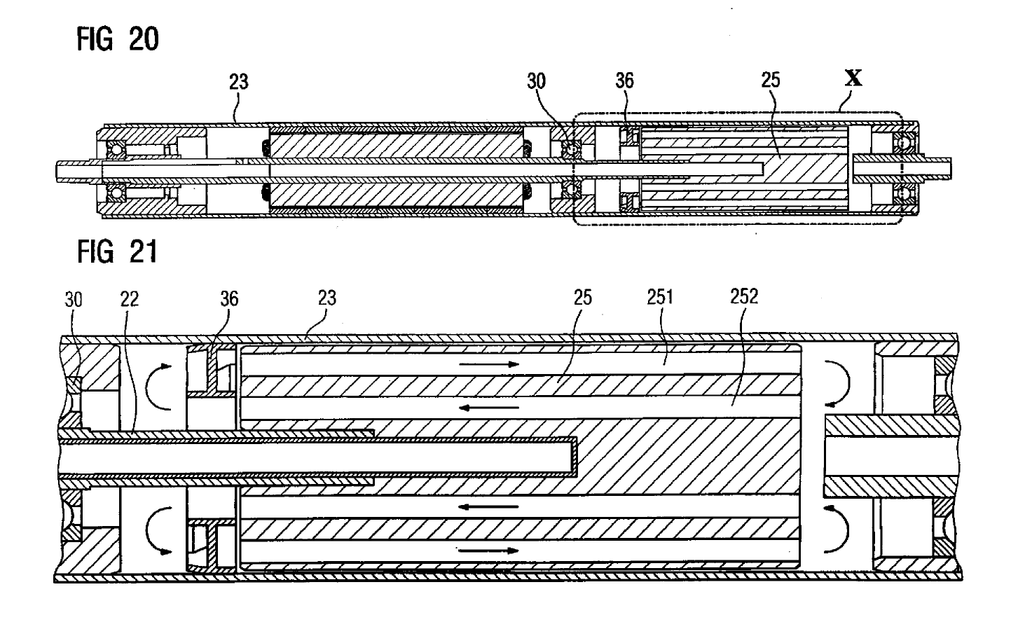

If passive heat removal is not sufficient, for example, fans can be added. A corresponding sixth embodiment for heat removal from the roller is shown in FIGS. 20 and 21. FIG. 21 shows, as before, an enlarged detail X of FIG. 20. The construction of the roller corresponds essentially to that of FIG. 12. A fan wheel 36 is arranged coaxially between the bearing 30 and the heat sink 25. The heat sink 25 also includes axial cooling channels 251 and 252. One section of the cooling channels 251 is arranged outside in the radial direction, whereas the other section 252 is arranged inside the heat sink 25 also in the radial direction. Air spaces are provided on the end faces of the heat sink, which interconnect the radially inner and radially outer cooling channels 251 and 252.

The fan wheel 36, which can be connected with a bearing shield as a single piece, is non-rotatably connected with the outer tube 23 of the roller. The heat sink 25, on the other hand, is fixedly secured on the shaft 22 and does not rotate. The relative movement between the fan wheel 36 and the heat sink 25 produces an air current which is indicated in FIG. 21 by arrows. The heat sink 25 thereby removes the heat to the surrounding air, in particular in the cooling channels 252, which is then carried by the fan wheel 36 near the outer tube 23. This improves heat removal in the radial direction.

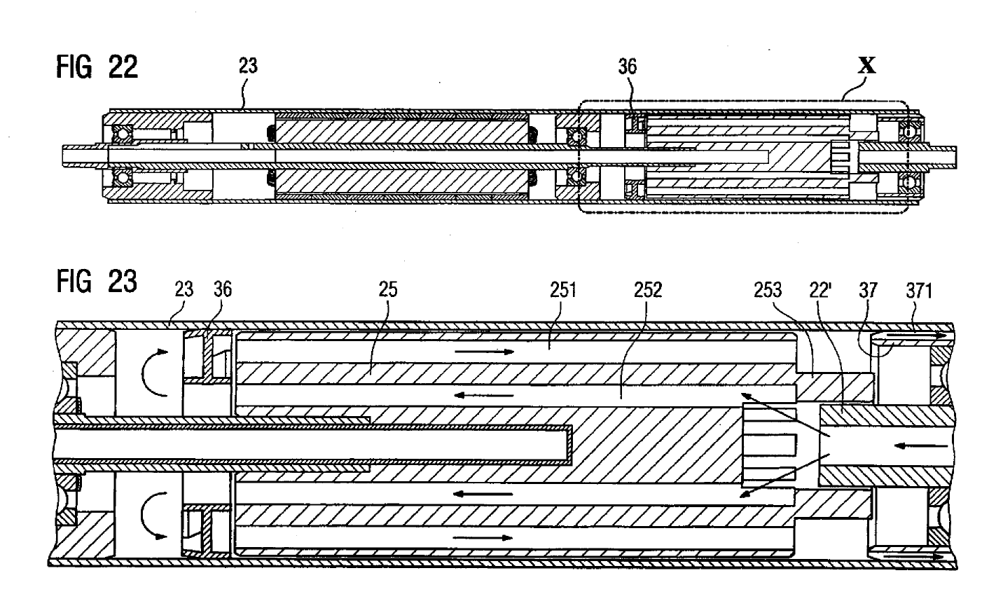

FIGS. 22 and 23 show a sixth embodiment for heat removal from rollers. FIG. 23 shows, as before, an enlarged detail X of FIG. 22. The construction of the roller corresponds essentially to that of FIG. 20. In this embodiment, a fan wheel 36 is also arranged inside the roller. Unlike the sixth embodiment depicted in FIGS. 20 and 21, heat is in this embodiment not removed by air circulation, but rather by exhausting the air. The corresponding cooling air flow is indicated in FIG. 23 by arrows. The cooling air flows from the outside into the interior of the roller through the bearing shield and the shaft section 22′, respectively. From there, the cooling air continues to flow through the inner cooling channels 252, where the cooling air is diverted and returns, aided by the fan 36, to the outer cooling channels 251. Bores or recesses 371 are provided in an outer bearing shield section 37, through which the cooling air flows from the roller to the outside. To stabilize this flow pattern, the heat sink 25 has a tubular extension 253 which protrudes over the shaft section 22′ and provides a sealing function.

As an alternative to the sixth and seventh embodiment, a hollow shaft exhaust can also be used for heat removal from the motor (not shown). In this embodiment, a fan wheel can also be disposed inside the roller. The air flows here in an axial direction through the hollow shaft of the roller and through holes in the bearing shield sections 22′ and/or 37.

In another variant for heat removal of the external rotor motor 24, air gap ventilation can be provided. The air flow driven by a fan wheel flows as before in the axial direction through the air gap of the external rotor motor and also through holes in the bearing shield sections 22′ and/or 37.

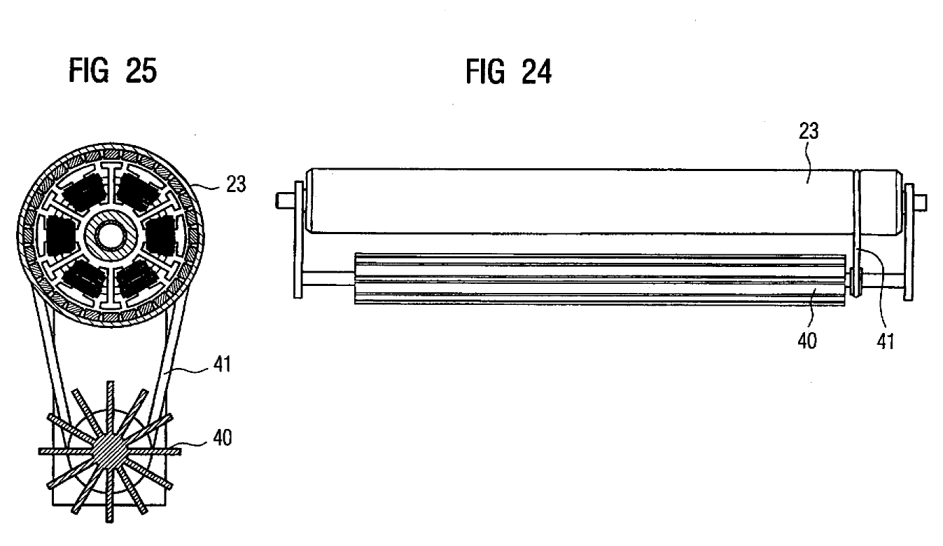

An eighth embodiment for heat removal from the roller is shown in FIGS. 24 and 25. FIG. 24 shows a top view and FIG. 25 a cross-sectional view of an externally exhausted roller. An external fan 40 is driven by the outer tube 23 of the roller via a belt 41. The fan 40 and the roller are arranged with mutually parallel axes. The blade wheels of the fan 40 provide a cooling air flow around the outer tube 23 of the roller.

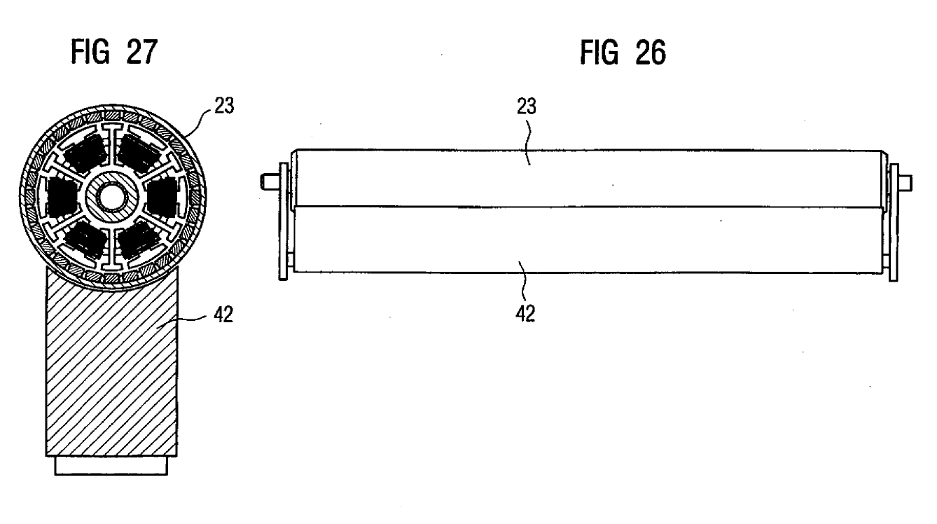

FIGS. 26 and 27 show a ninth embodiment for heat removal from the roller with an integrated roller motor. A heat scraper 42 is arranged parallel to the roller, with heat transferred from the outer tube 23 to the heat scraper 42 by radiation and convection. An air gap is arranged between the outer tube 23 and the heat scraper 42, so that the roller is not braked. The heat scraper 42 is cooled intensively, so that enough heat is transferred to the heat scraper 42 when it moves past the outer tube 23. In alternative embodiment, the heat scraper 42 can be replaced by a heat-conducting roller.

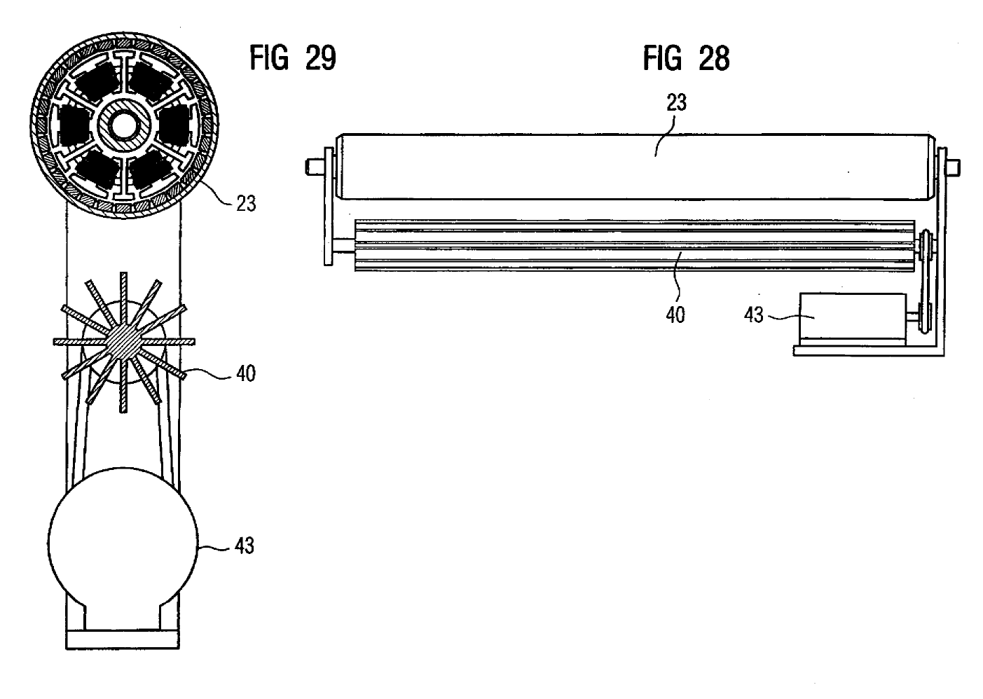

FIGS. 28 and 29 show schematically active cooling with an external fan or another suitable device. FIG. 28 shows a top view of the roller with external fan and FIG. 29 shows a cross-sectional view of the roller. The external fan 40, which is here also a cross-flow fan, is driven by a separate fan motor 43.

As already mentioned above, an external fan can also be used with a hollow shaft exhaust and an air gap exhaust. Another alternative to active cooling is a heat pump. In this case, for example, an external small compressor or Peltier elements can be used for cooling the rollers.

In the aforedescribed embodiments, the roller motor can be implemented as a harmonic motor which employs the higher harmonics of the air gap field. Small motors with a large number of poles can then be constructed. Due to the large number of poles, the motor requires less iron, which can be replaced by copper, thereby reducing electric heat losses.

FIG. 30 shows schematically a harmonic motor of this type. Advantageously, the stator is constructed with alternating wide teeth 50 and narrow teeth 51, whereby only each wide tooth 50 is surrounded by a winding 52. The ratio of the pitch width τ_{zb} of the wide tooth 50 to the pole pitch τₚ of the rotor poles can be expressed as τ_{zb}>2.5 τp. Reference is made here to the published patent application DE 101 33 654 A1 by the present applicant.

FIG. 30 shows an exemplary 28-pole rotor with 28 individual magnets 53 cooperating with the stator which has six wide teeth 50 and six narrow teeth 51. The stator has a basic pole number of 2p_{G}=4. The motor therefore operates with the seventh harmonic of the air gap field. The pitch ratio is here, for example, τ_{Zb}/τₚ≈3.

The aforementioned roller motors can be operated without requiring a separate rotor position transducer. In one practice, the EMF of the motor is used to detect the rotor position and to apply the proper current to the motor phases. A design without a rotor position transducer has considerable advantages, because it simplifies the motor design and assembly.

The aforedescribed rollers and roller motors can have large linear dimensions. However, a cover slider as a slot closure for the stator is difficult to apply in the axial direction when the linear dimensions are large and slot fill is extreme. In its place, for example, a round material can be radially inserted into the slot gap as a slot closure. The diameter of the round material should be slightly oversized with respect to the dimension of the slot gap, so that the material is compressed during insertion, thereby holding the winding in position. If the round material is implemented as a paper cord, then it can be impregnated with a resin and adhesively secured in the slot. This type of slot closure for the stator is schematically indicated in FIG. 31. The round material 54 is arranged in the corresponding slot gap 55 and thereby closes the slot below where a corresponding winding 52 is positioned.

In certain applications, the rollers of a roller system must be braked. According to the invention, a braking system is provided which can be integrated in the roller.

FIG. 32 shows in cross-section a braking system 60 which is mounted on a stationary axle 61. A bearing bushing 62 adapted to receive a drum, a roller, or a motor is supported on the axle 61 in two places. A bearing shield 63, which transfers the rotary motion and the torque from the bearing bushing 62 to the braking unit 60, is non-rotatably connected with the bearing bushing 62.

The braking unit 60 is shown schematically in FIG. 32 as a spring-biased brake. It includes in coaxial alignment an axially movable anchor plate 601, a toothed friction plate 602 movable in the axial direction, and a friction surface 603. The anchor plate 601 and the friction disk 602 are moved by a magnet body 604 with springs.

This braking unit 60 operates like a conventional spring-biased brake. After the operating voltage of the brake is turned off, the toothed, axially movable friction disk 602 is urged against the friction face 603 by the springs located in the magnet body 604 and the axially movable anchor plate 601. The friction torque produced by the normal component of the force brakes the rotating components, such as the bearing shield 63 and the bearing bushing 62. The torque is transferred via the stationary axle 61 to the support construction for the rollers, which is formed, for example, by the faces 34 (see FIG. 18). The required electric current for the brake is advantageously applied through a power cable 64 which is routed through the hollow shaft 61 of the braking unit 60.

FIG. 33 shows a typical installation of the braking unit 60 depicted in FIG. 32. The braking unit 60 is here integrated in a tube 65. This tube 65 can be part of a drum, a roller, an external rotor motor, etc. The tube 65 makes contact with the bearing bushing 62 and rotates with the bearing bushing 62.

The braking system, which can be integrated in the roller or the rotating sleeve, and the drive unit, which can also be integrated, can therefore be viewed as a single unit which can be easily and quickly assembled. The mechanical interface between the braking unit and the rotating body, which can be individually implemented in the form of a flange, compression joint or shrink-fit, also facilitates disassembly.

The braking effect can be enhanced and modified by using several brakes or brake units for each drive unit, for example on both ends of a roller.

A thermally decoupled braking system and motor system can also be used for applications that are extremely heat-sensitive, for example for manufacturing foils or food items. Decoupling the braking system from the motor has the additional advantage that motors with braking functionality can be eliminated from applications that do not require braking.

The aforedescribed rollers and roller motors can also be employed in roller conveyers for the materials-handling technology in mail and parcel distribution centers, in safety and delay elements (path controls) in the textile and paper processing industry, as well as in textile spindles and galette rollers.

1.-38. (canceled)

39. A roller motor comprising
an external rotor having a flux return tube and a plurality of individual magnets arranged on an inner circumference of the flux return tube, and
a support unit arranged at least partially radially inside the individual magnets, the support unit including axially extending, outwardly oriented spacers for spacing the individual magnets in the circumferential direction.

40. The roller motor of claim 39, wherein a pole of the rotor is implemented by a combination of two or more of the individual magnets.

41. The roller motor of claim 39, wherein the support unit is formed as a tube or a sleeve.

42. The roller motor of claim 39, wherein the support unit made of plastic.

43. The roller motor of claim 39, wherein the support unit includes a bed filled with an adhesive, with the adhesive securing the plurality of individual magnets on the support unit.

44. The roller motor of claim 41, wherein sections of the tube of the support unit have walls of different thicknesses.

45. The roller motor of claim 39, wherein an interior section of the support unit is turned out radially, while leaving in place residual support sections located radially below the spacers for supporting individual magnets having a rectangular cross-section.

46. A method for producing a roller motor or an external rotor motor, comprising the steps of
providing a tubular support unit having axially extending, outwardly oriented spacers,
affixing a plurality of individual magnets or magnet blanks on an outer circumference of the tubular support unit, wherein each of the individual magnets or magnet blanks is affixed between two corresponding spacers,
inserting the support unit with the affixed individual magnets or magnet blanks in a flux return tube, and
securing the inserted support unit on an inner circumference of the flux return tube.

47. The method of claim 46, further comprising the step of magnetizing the magnet blanks after the support unit is secured in the flux return tube.

48. The method of claim 46, further comprising the step of turning the support unit out radially, thereby leaving only the spacers in place between the individual magnets or magnet blanks.

49. The method of claim 46, wherein the securing step comprises pressing the support unit against the flux return tube with an expansion arbor.

50. A roller motor comprising
a shaft divided into a first shaft section and a second shaft section,
a stator arranged on the shaft, and
a contacting device for contacting the stator with power supply lines, said contacting device including two contact supports,
wherein a first of the two contact supports is arranged on the first shaft section and the second contact support is arranged on the second shaft section, and wherein the first and the second contact supports are inserted into each other to form a removable electrical connection.

51. The roller motor of claim 50, wherein the first contact support includes clamping devices for interconnecting at least a winding head of the stator.

52. The roller motor of claim 51, wherein at least one of the clamping devices includes an insulation displacement contact.

53. The roller motor of claim 50, further comprising a sensor arranged on the first contact support, with the sensor being electrically contacted by the two contact supports.

54. The roller motor of claim 51, wherein the clamping devices secure free ends or slack sections of winding wires of the stator.

55. The roller motor of claim 50, wherein the second shaft section is hollow and wires for contacting the second contact support are routed to an interior space of the second shaft section through at least one bore or recesses disposed in the second shaft section.

56. The roller motor of claim 50, wherein an end of the second shaft section that faces away from the first shaft section includes a plug, which is electrically connected to the second contact support.

57. A roller with an integrated roller motor, comprising a cooling device which is integrated in the roller or is located outside the roller.

58. The roller according to claim 57, wherein the cooling device includes a heat sink and a first heat pipe.

59. The roller according to claim 57, wherein the roller motor is an external rotor motor having an outer tube, said outer tube operating as a flux return tube of the external rotor motor.

60. The roller according to claim 59, wherein the outer tube of the roller is split into two sections perpendicular to its axial direction, and wherein the roller motor is arranged in one of the split sections.

61. The roller according to claim 57, wherein a thermal insulation layer is applied an outer surface of the roller.

62. The roller according to claim 58, further comprising a bearing shield and a second heat pipe partially arranged in the cooling device for transporting heat from the heat sink to the bearing shield.

63. The roller according to claim 57, further comprising a fan wheel arranged inside the roller to provide cooling by at least one of circulating air, vented air, hollow shaft ventilation and air gap ventilation.

64. The roller according to claim 57, wherein the cooling device includes a self-ventilated fan, a separate fan, a heat wiper, a heat-conducting roller or a heat pump, or a combination thereof.

65. The roller according to claim 57, wherein the roller motor is a harmonic motor.

66. The roller according to claim 57, wherein a rotor position of the roller motor is determined from an electromotive force of the roller motor.

67. The roller according to claim 57, wherein the roller motor is an external rotor motor having a stator with stator slots, with the stator slots being closed by inserting a round material radially into the stator slots.

68. A method for removing heat from at least one section of a roller having an integrated roller motor, comprising transporting heat dissipated in the roller motor to a cooling device, which is also integrated in the roller or is located outside the roller.

69. The method of claim 68, wherein the heat dissipated in the roller motor is transported to a cooling device by way of a heat pipe.

70. A roller, comprising:
a shaft which supports the roller for rotation, and
a braking device arranged inside the roller for braking the roller.

71. The roller of claim 70, further comprising a roller motor integrated in the roller, wherein the braking device is indirectly coupled to an outer tube of the roller.

72. The roller of claim 70, wherein the braking device is an electromagnetic braking device.

73. The roller of claim 70, further comprising a roller motor integrated in the roller, wherein the braking device is arranged in the roller motor.

74. The roller of claim 70, wherein the shaft is hollow and wherein power supply lines for the braking device are routed through the hollow shaft.

75. The roller motor of claim 39 for use with a roller.

76. The roller motor of claim 50 for use with a roller.
